(19) United States
(12) Patent Application Publication
(10) Pub. No.: US 2026/0352477 A1
(43) Pub. Date: Nov. 5, 2026

(54) SECURING AGENT DEPLOYMENT USING ZERO-KNOWLEDGE PROOFS

(71) Applicant: Cisco Technology, Inc., San Jose, CA (US)

(72) Inventors: Dennis Lanov, Richardson, TX (US); Sergiu Calmic, Bruxelles (BE)

(21) Appl. No.: 19/199,090

(22) Filed: May 5, 2025

(51) Int. Cl. H04L 9/32; H04L 9/06

(52) U.S. Cl. CPC H04L 9/3221; H04L 9/0643

(57) ABSTRACT

Techniques for secure deployment and verification of agents in computing architectures, such as containerized environments, using zero-knowledge proofs. Unlike conventional verification methods that may expose sensitive information or rely on centralized trust models, this approach enables software agents to prove their integrity and authenticity without revealing their internal configuration or code. Prior to deployment, an agent may use generate a cryptographic commitment that proves that the agent possesses pre-image code, but obfuscates the actual code using a random nonce and the pre-image code as inputs into a hashing function. The commitment may then be used by an agent verification system to verify whether the agent possesses pre-image code that is for an approved version. By leveraging zero-knowledge proofs, the techniques enhance security, preserve privacy, and support dynamic deployment in computing architectures, addressing limitations of traditional agent verification techniques in containerized systems.

### TECHNICAL FIELD

The present disclosure relates generally to verifying software agents using zero-knowledge proofs (ZKPs) prior to deploying the agents into containerized computing environments.

### BACKGROUND

Software agents are increasingly being deployed in containerized environments due to the operational benefits of containerization and the growing demand for intelligent, autonomous components in modern software systems. Containers offer a lightweight, consistent, and portable runtime environment that enables rapid deployment, scalability, and isolation across heterogeneous infrastructure. These characteristics align well with the requirements of software agents, which often perform discrete tasks such as monitoring, decision-making, data processing, or automation. By deploying agents in containers, organizations can manage them more efficiently, scale them on demand, and update or replace them with minimal impact on the broader system.

However, the deployment of software agents in containerized environments introduces a range of security complexities related to verifying software agents prior to deployment. While containerization technologies such as Docker and orchestration frameworks like Kubernetes provide flexibility and scalability, they also expose new attack surfaces and complicate traditional security models. This deployment issue has become increasingly important as organizations rely more heavily on distributed systems and cloud infrastructure, where monitoring and observability are crucial for maintaining security and performance.

Existing systems attempting to address the agent verification problem encounter several obstacles. These include the need to expose sensitive configuration details or internal metrics during verification processes, which can create security vulnerabilities. Additionally, current methods often struggle to provide a balance between robust verification and maintaining the privacy of the agent's operational logic, limiting their effectiveness in scenarios where both security and confidentiality are paramount.

For instance, in scenarios where one or more entities need to verify an agent's compliance with security policies, current solutions may require sharing of actual measurement values or key performance indicators, potentially exposing sensitive operational data. Another example is in multi-tenant environments, where existing methods are unable to provide strong assurances of agent integrity without risking the exposure of proprietary information or creating opportunities for side-channel attacks. These limitations highlight the need for more sophisticated approaches that can provide robust verification while preserving the confidentiality of sensitive information.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which an agent uses a ZKP to verify that it possesses pre-image data that is approved for deployment into a computing environment.

FIG. 2 illustrates an example component diagram of an agent verification system that verifies agents prior to the agents being deployed into a computing environment.

FIGS. 3A and 3B collectively illustrate a flow diagram of an example method for an agent to verify that it possesses pre-image data that is approved for deployment into a computing environment.

FIG. 4 illustrates an example diagram in which an agent generates a commitment that proves to an agent verification system that the agent possesses approved pre-image data and is allowed to be deployed into a computing environment.

FIG. 5 illustrates a flow diagram of an example method for an agent to utilize a ZKP to verify that it possesses pre-image data that is approved for deployment into a computing environment.

FIG. 6 illustrates a flow diagram of an example method for an agent verification system to utilize a ZKP to verify that an agent it possesses pre-image data that is approved for deployment into a computing environment.

FIG. 7 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to verifying software agents using zero-knowledge proofs (ZKPs) prior to deploying the agents into containerized computing environments. The software agents use ZKPs to prove to an agent verification system they are in possession of code (e.g., pre-image data) that is of an approved version without having to actually expose the code.

A first method described herein may be performed by an agent and include receiving an instruction to be deployed into a containerized environment. Further, the first method may include, prior to deployment of the agent, receiving a request to prove that the agent is of an approved version that is allowed to be deployed into the containerized environment, and generating a ZKP to prove to the agent verification system that the agent has pre-image data associated with the approved version of the agent. The first method may further include sending the ZKP to the agent verification system, and receiving, from the agent verification system, a verdict indicating whether the ZKP proved that the agent has the pre-image data and is allowed to be deployed into the containerized environment. In response to the verdict indicating that ZKP proved that the agent has the pre-image data, the first method may include allowing the agent to be deployed in the containerized environment. Conversely, in response to the verdict indicating that ZKP failed to prove that the agent has the pre-image data, the first method may include preventing the agent from being deployed in the containerized environment.

A second method described herein may be performed by an agent verification system and include determining that an agent is to be deployed into a containerized environment, and sending, prior to deployment, a request to prove that the agent is of an approved version that is allowed to be deployed into the containerized environment. The second method may further include receiving, from the agent, a ZKP to prove that the agent has pre-image data associated with the approved version of the agent, and determining whether the ZKP proved that the agent has the pre-image data and is allowed to be deployed into the containerized environment. In response to determining that the verdict is that the ZKP was verified, the second method includes sending the verdict to cause the agent to be deployed. Conversely, in response to determining that the verdict is that the ZKP was not verified, the second method includes sending the verdict to prevent the agent from being deployed.

Additionally, the techniques of at least the first method and the second method and any other techniques described herein, may be performed by a system and/or device having non-transitory computer-readable media storing computer-executable instructions that, when executed by one or more processors, performs the method(s) described above.

### Example Embodiments

This disclosure describes techniques for secure deployment and verification of agents in computing architectures, such as containerized environments, using zero-knowledge proofs. Unlike conventional verification methods that may expose sensitive information or rely on centralized trust models, this approach enables software agents to prove their integrity and authenticity without revealing their internal configuration or code. Prior to deployment, an agent may use generate a cryptographic commitment that proves that the agent possesses pre-image code, but obfuscates the actual code using a random nonce and the pre-image code as inputs into a hashing function. The commitment may then be used by an agent verification system to verify whether the agent possesses pre-image code that is for an approved version. By leveraging zero-knowledge proofs, the techniques enhance security, preserve privacy, and support dynamic deployment in computing architectures, addressing limitations of traditional agent verification techniques in containerized systems.

Current containerized environments and cloud-native infrastructures face challenges in securely deploying and verifying the integrity of observability agents. These agents, responsible for collecting critical metrics, logs, and traces, may be compromised or altered, potentially leading to security vulnerabilities or inaccurate monitoring data. Existing verification methods often rely on traditional certificate-based authentication or hash comparisons, which may expose sensitive information about the agents or the underlying infrastructure during the verification process.

Conventional approaches to agent verification in containerized environments have several limitations. Certificate-based methods require complex management of digital signatures and can introduce delays in deployment processes. Direct hash comparisons necessitate the transmission of hash values, which may be intercepted or manipulated. Additionally, these methods often lack the flexibility required for rapidly evolving containerized architectures, where agents need to be dynamically injected, updated, or removed with minimal overhead. These shortcomings highlight the need for a more secure, efficient, and privacy-preserving approach to agent verification in modern cloud-native ecosystems.

The present disclosure describes techniques for securely deploying and verifying observability agents in containerized environments using zero-knowledge proofs. This approach addresses the challenges of ensuring agent integrity and authenticity without exposing sensitive information about the agents or the underlying infrastructure.

Initially, a software agent may receive an instruction to be deployed into a containerized environment. The instruction may be received from various entities, such as a scheduling service, a scaling service, or a container orchestration system. Prior to being deployed into the containerized environment, however, the agent may send a deployment request to an agent verification system that is in a control plane of the containerized environment.

According to the techniques described herein, the software agent may generate a zero-knowledge proof (ZKP) to demonstrate to the agent verification system that the software agent has pre-image data associated with the approved version. Generally, a ZKP is a cryptographic method that allows one party (the “prover,” or the agent here) to convince another party (the “verifier,” or the agent verification system here) that a certain statement is true, without revealing any information beyond the fact that the statement is true. The agent may wish to prove ownership of verified or allowed pre-image data such that the agent is allowed to be provisioned into the containerized environment, but does not want to reveal the pre-image data or an integrity hash of the pre-image data. The agent may select a random nonce, or receive the nonce, and combine their pre-image data, or integrity hash, with the random nonce as inputs into a hash function. The hash function generates a unique value called the commitment, and the agent then sends the commitment to the agent verification system. The agent may further send the random nonce value to the agent verification system as part of the ZKP.

The agent verification system may receive, from software vendors or other entities, approved versions of the agents that are permitted or allowed to be deployed into the containerized environment. In some instances, the agent verification system may receive the actual code, such as pre-image code, from the vendors, and in other examples the agent verification system may receive hashes of the pre-image code so as to obfuscate the actual code. The hashes of the pre-image code (referred to herein as “integrity hashes”) may be stored at the agent verification system in an agent integrity registry.

The agent verification system may receive the commitment and the nonce, and may also obtain the integrity hash(es) for approved versions of the agent (e.g., approved code, such as pre-image data). The agent verification system may then cryptographically verify that the commitment represents the integrity hash (and/or the actual pre-image data/code) using the random nonce. The agent verification system may then return a verdict to the agent based on the result of the ZKP used to verify that the agent possesses pre-image data that is allowed or permitted to be deployed into the containerized environment.

In some instances, the verdict may indicate that the ZKP proved that the software agent has the pre-image data and is allowed to be deployed into the containerized environment. Based on this verdict, the software agent may be deployed if the zero-knowledge proof is verified. Alternatively, the verdict may indicate that the ZKP was unable to successfully prove that the software agent has the pre-image data, and based on this verdict, the software agent may be prevented from being deployed due to the verification failing.

The present disclosure relates to the field of containerized software environments and agent-based monitoring systems, specifically focusing on secure deployment and verification of observability agents in dynamic, distributed computing architectures. This technology addresses the growing need for robust monitoring and observability solutions in cloud-native infrastructures, where the integrity and authenticity of monitoring agents are crucial for maintaining system security and reliability. The disclosure features a seamless integration with existing container orchestration systems, enabling dynamic and scalable deployment of observability agents across distributed containerized environments. The system may include an agent verification module that generates and evaluates zero-knowledge proofs, working in conjunction with a container integration module to manage the lifecycle of agents within the infrastructure. This approach not only enhances security but also improves operational efficiency by streamlining the agent deployment process and reducing the overhead associated with traditional verification methods. The invention's flexibility and scalability make it particularly well-suited for modern cloud-native architectures, where rapid adaptation to changing environments and workloads may be essential.

Within the context of the present disclosure, “zero-knowledge proof” refers to a cryptographic method for verification without revealing sensitive information. For example, a zero-knowledge proof may allow a software agent to prove its integrity to an agent verification system without disclosing its actual code or configuration. Within the context of the present disclosure, “containerized environment” refers to a virtualized computing infrastructure using containers. For example, in one embodiment, a containerized environment may be a Kubernetes cluster where multiple software agents are deployed across different nodes for monitoring and observability purposes. Within the context of the present disclosure, “agent” refers to a software component that performs tasks, makes decisions, and adapts to changing conditions autonomously or semi-autonomously. For example, the agent may be an observability agent may be deployed within a container to monitor application performance, resource utilization, and network traffic in a microservices architecture. Within the context of the present disclosure, “pre-image data” refers to the original input used to calculate a cryptographic hash. For example, in one embodiment, pre-image data may be the source code or configuration files of an observability agent, which when hashed, produce a unique identifier used in the verification process.

While some of the techniques are described herein as being performed using a hash-based ZKP, any type of ZKP may be utilized to perform the techniques described herein. Additionally, the techniques of this application are often described with respect to deploying an agent into a containerized environment, the techniques are generally applicable for deploying an agent into any computing environment. The agent may be any type of agent, such as observability agents that monitor metrics and performance of workloads, AI agents, security agents, etc. Further, the techniques are described with respect to agents, but the techniques are generally applicable for any software or process that is to be executed or hosted in a computing system or environment.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

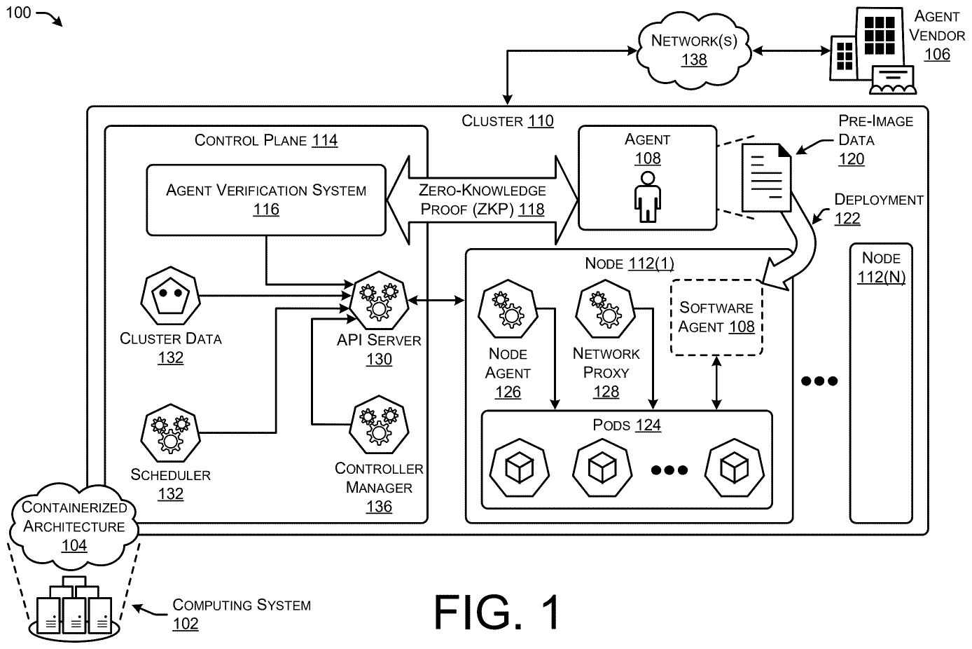

FIG. 1 illustrates a system-architecture diagram of an environment 100 in which an agent uses a ZKP to verify that it possesses pre-image data that is approved for deployment into a computing environment.

The environment 100 may include a computing system 102 that, in some examples, may comprise devices housed or located in one or more data centers and that support a containerized architecture 104. The computing system 102 may include one or more networks implemented by any viable communication technology, such as wired and/or wireless modalities and/or technologies. The computing system 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The computing system 102 may include devices, virtual resources, or other nodes that relay packets from one network segment to another by nodes in the computer network. The computing system 102 may include multiple devices that utilize the network layer (and/or session layer, transport layer, etc.) in the OSI model for packet forwarding, and/or other layers. The computing system 102 may include various network devices, such as routers, switches, gateways, firewalls, smart NICs, NICs, ASICs, FPGAs, servers, and/or any other type of device. Further, the computing system 102 may include virtual resources, such as VMs, containers, containers, and/or other virtual resources. However, the computing system 102 may be of a different type of architecture, such as a WAN, IoT network, cellular network, or any other type of network.

The one or more data centers may be physical facilities or buildings located across geographic areas that designated to store networked devices that are part of the computing system 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices may not be located in explicitly defined data centers, but may be located in other locations or buildings.

The computing system 102, which serves as the primary platform for hosting and managing containerized applications and services. This computing system 102 could be a high-performance server, a cloud-based infrastructure, or a distributed computing environment capable of handling complex containerized workloads. Within the computing system 102 resides the containerized architecture 104, which is an advanced software deployment and management framework. This architecture leverages container technology to encapsulate applications and their dependencies, enabling consistent deployment across different environments and improving resource utilization and scalability.

The containerized architecture 104 communicates with an agent vendor 106 through one or more networks 138. The agent vendor 106 is a specialized service provider that supplies and manages software agents crucial for monitoring, security, and operational tasks within the containerized environment. These agents could include security monitors, performance optimizers, or compliance checkers. The network 138 connecting the containerized architecture and the agent vendor could be a secure, high-speed internet connection, a dedicated private network, or a virtual private network (VPN) ensuring safe and efficient data transfer.

At the heart of the containerized architecture 104 is a cluster 110, which is a group of interconnected computing resources that work together as a unified system. This cluster contains multiple nodes, ranging from a first node 112(1) through an nth node 112(N). Each node 112 represents an individual computing instance, which could be a physical machine, a virtual machine, or a containerized environment itself, capable of running multiple containers.

Overseeing the operation of this cluster is the control plane 114, a critical component of the containerized architecture. The control plane 114 is responsible for managing the overall state of the cluster, including tasks such as scheduling containers, managing network traffic, handling storage, and ensuring the desired state of the applications running in the cluster. It acts as the brain of the containerized environment, making decisions about where to place containers, how to scale applications, and how to respond to failures or changes in the system.

The control plane 114 is a sophisticated orchestration layer that serves as the nerve center of the containerized architecture. It contains several critical components, each playing a vital role in managing and securing the cluster operations. One of the key components within the control plane 114 is the agent verification system 116. This system is responsible for authenticating and validating the software agents deployed across the cluster. It ensures that only authorized and uncompromised agents are allowed to operate within the containerized environment. The agent verification system 116 implements ZKP 118 functionality, which is an advanced cryptographic protocol. This zero-knowledge proof (ZKP) 118 allows the system to verify the authenticity and integrity of agents without exposing sensitive information, thereby enhancing security while maintaining privacy.

Another crucial component of the control plane 114 is the API server 130. This server acts as the front-end for the control plane, exposing the cluster's API (Application Programming Interface). It processes REST operations and provides the primary interface for users, administrators, and external systems to interact with the cluster. The API server 130 validates and configures data for API objects such as pods, services, and replication controllers, and updates the corresponding objects in the cluster's persistent store.

The scheduler 132 is another vital component within the control plane 114. It is responsible for assigning newly created pods or other unassigned objects to nodes within the cluster. The scheduler 132 takes into account various factors such as resource requirements, hardware/software constraints, affinity and anti-affinity specifications, data locality, and workload interference when making placement decisions. This ensures optimal utilization of cluster resources and maintains the overall performance and efficiency of the containerized environment.

Lastly, the control plane 114 includes a controller manager 136. This component is responsible for running various controllers that regulate the state of the system. These controllers are control loops that watch the state of the cluster through the API server and make changes attempting to move the current state towards the desired state. Examples of controllers include the node controller (for noticing and responding when nodes go down), the replication controller (for maintaining the correct number of pods for every replication controller object in the system), and the endpoints controller (for populating the Endpoints object, which links services and pods). Together, these components of the control plane 114 work in concert to ensure the smooth operation, security, and efficiency of the entire containerized architecture.

Initially, a agent 108 may receive an instruction to be deployed into the containerized architecture 104. The instruction may be received from various entities, such as the scheduler 132, a scaling service, or a container orchestration system (e.g., controller manager 136). These entities could be part of the control plane 114 or external systems interacting with the containerized architecture 104. Prior to being deployed into the containerized architecture 104, however, the agent 108 may send a deployment request to an agent verification system 116 that is in the control plane 114 of the containerized architecture 104. This pre-deployment verification process ensures that only authorized and secure agents are allowed to operate within the cluster 110.

According to the techniques described herein, the agent 108 may generate a ZKP 118 to demonstrate to the agent verification system 116 that the agent 108 has pre-image data 120 associated with the approved version. Generally, a ZKP 118 is a cryptographic method that allows one party (the “prover,” or the agent 108 here) to convince another party (the “verifier,” or the agent verification system 116 here) that a certain statement is true, without revealing any information beyond the fact that the statement is true. The agent 108 (also referred to herein as “software agent”) may wish to prove ownership of verified or allowed pre-image data such that the agent 108 is allowed to be provisioned into the containerized architecture 104, but does not want to reveal the pre-image data or an integrity hash of the pre-image data. This approach maintains the security and integrity of the agent's code while still allowing for verification. The agent 108 may combine their pre-image data, or integrity hash, with a random nonce as inputs into a hash function. The hash function generates a unique value called the commitment, and the agent 108 then sends the commitment to the agent verification system 116. The agent 108 may further send the random nonce value to the agent verification system 116 as part of the ZKP 118. This process ensures that the verification can be performed without exposing sensitive information.

The agent verification system 116 may receive, from software vendors or other entities such as the agent vendor 106, approved versions of the agents that are permitted or allowed to be deployed into the containerized architecture 104. In some instances, the agent verification system 116 may receive the actual code, such as pre-image code, from the vendors, and in other examples the agent verification system 116 may receive hashes of the pre-image code so as to obfuscate the actual code. The hashes of the pre-image code (referred to herein as “integrity hashes”) may be stored at the agent verification system 116 in an agent integrity registry. This registry serves as a trusted reference point for verifying the authenticity and integrity of agents attempting to deploy in the containerized architecture 104.

The agent verification system 116 may receive the commitment and the nonce from the agent 108, and may also obtain the integrity hash(es) for approved versions of the agent (e.g., approved code, such as pre-image data) from its agent integrity registry. The agent verification system 116 may then cryptographically verify that the commitment represents the integrity hash (and/or the actual pre-image data/code) using the random nonce. This verification process leverages the properties of the ZKP 118 to confirm the agent's authenticity without exposing sensitive information. The agent verification system 116 may then return a verdict to the agent 108 based on the result of the ZKP 118 used to verify that the agent 108 possesses pre-image data that is allowed or permitted to be deployed into the containerized architecture 104.

In some instances, the verdict may indicate that the ZKP 118 proved that the agent 108 has the pre-image data and is allowed to be deployed at deployment step 122 into the containerized architecture 104. Based on this verdict, the agent 108 may be deployed if the zero-knowledge proof is verified. This successful verification allows the agent 108 to be safely integrated into the cluster 110. Alternatively, the verdict may indicate that the ZKP 118 was unable to successfully prove that the agent 108 has the pre-image data, and based on this verdict, the agent 108 may be prevented from being deployed due to the verification failing. This prevention mechanism ensures that only verified and trusted agents are allowed to operate within the containerized architecture 104, maintaining the security and integrity of the entire system.

As shown, in examples where the verdict indicates that the ZKP 118 proved that the agent 108 has the pre-image data and is allowed to be deployed into the containerized architecture 104, the agent 108 may be deployed into the node 112(1) to perform various operations.

As illustrated, the node 112 may include a node agent 126 that runs on each node 112 and registers the node 112 with the API server 130 using one of: the hostname; a flag to override the hostname; or specific logic for a cloud provider. The node agent 126 works in terms of a PodSpec, which may be a YAML or JSON object that describes a pod 124. The node 112 may further include a network proxy 128 that is a component that facilitates network communication between pods 124 and services within the cluster 110. The network proxy 128 runs on each node 112 and manages network rules, allowing pods 124 to connect to each other and to external services. Essentially, the network proxy 128 acts as a load balancer and a network gateway, enabling the core Kubernetes networking model.

The network(s) 138 may include any viable communication technology, such as wired and/or wireless modalities and/or technologies. Networks 138 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed—and/or any combination, permutation, and/or aggregation thereof. The devices described herein may communicate using any type of protocol over the network 138 such as the transmission control protocol/Internet protocol (TCP/IP) that is used to govern connects to and over the Internet.

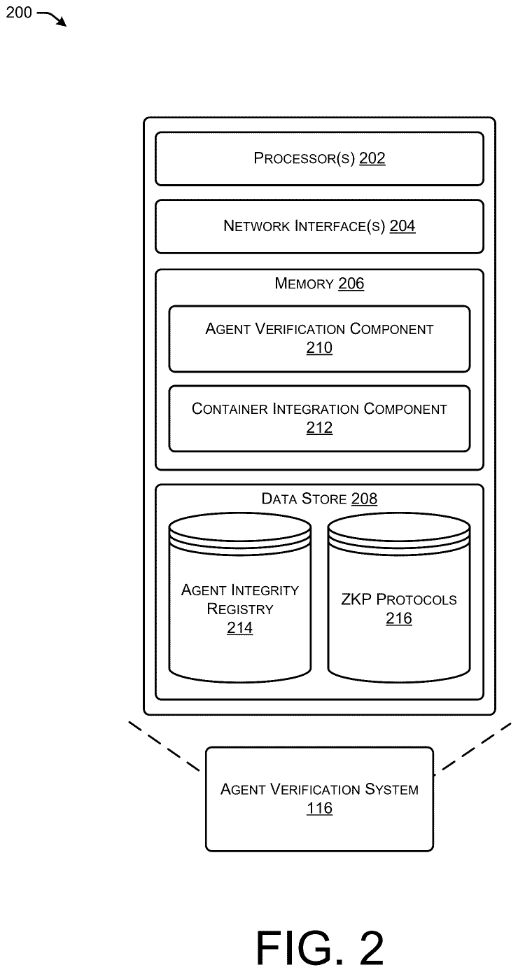

FIG. 2 illustrates an example component diagram 200 of an agent verification system 116 that verifies agents 108 prior to the agents 108 being deployed into a computing system 102.

As illustrated, the agent verification system 116 may include one or more hardware processors 202 (processors), one or more devices, configured to execute one or more stored instructions. The processor(s) 202 may comprise one or more cores. Further, the agent verification system 116 may include one or more network interfaces 204 configured to provide communications between the agent verification system 116 and other devices or entities. The network interfaces 204 may include devices configured to couple to personal area networks (PANs), wired and wireless local area networks (LANs), wired and wireless wide area networks (WANs), and so forth. For example, the network interfaces 204 may include devices compatible with Ethernet, Wi-Fi™, cellular or mobile protocols, and so forth.

The agent verification system 116 may also include computer-readable media (e.g., memory 206) that stores various executable components (e.g., software-based components, firmware-based components, etc.). In addition to various components discussed in FIG. 1, the computer-readable-media may further store components to implement functionality described herein. While not illustrated, the computer-readable media may store one or more operating systems utilized to control the operation of the one or more devices that comprise or support/execute the agent verification system 116. According to one embodiment, the operating system comprises the LINUX operating system. According to another embodiment, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

Additionally, the agent verification system 116 may include a data store 208 (e.g., long term storage) which may comprise one, or multiple, repositories or other storage locations for persistently storing and managing collections of data such as databases, simple files, binary, and/or any other data. The data store 208 may include one or more storage locations that may be managed by one or more database management systems.

The computer-readable media may be used to store and retrieve information, such as program modules, data structures, or other data. It should be appreciated by those skilled in the art that computer-readable storage media is any available media that provides for the non-transitory storage of data and that can be accessed by the agent verification system 116. In some examples, the operations performed by the agent verification system 116, and or any components included therein, may be supported by one or more server devices. Stated otherwise, some or all of the operations performed by the agent verification system 116, and or any components included therein, may be performed by one or more computer devices operating in various arrangements.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The memory 206 may store and provide rapid access to the agent verification component 210 and container integration component 212, which perform essential verification and integration functions respectively. The memory 206 could be implemented using various technologies such as DDR4 RAM or newer, providing low-latency access to ensure swift processing of verification requests.

The agent verification component 210, stored in memory 206, may be a software component responsible for generating and evaluating zero-knowledge proofs related to the agent 108. This component implements complex cryptographic algorithms to create and verify proofs without revealing sensitive information. It works within the containerized architecture 104 to rigorously verify the agent 108 before deployment in the cluster 110, ensuring that only authenticated and authorized agents 108 are allowed to operate within the environment.

The container integration component 212, also residing in memory 206, is a specialized software module designed to ensure seamless integration with the containerized architecture 104. This component acts as a bridge between the verification system and the container orchestration platform, such as Kubernetes. In some cases, the container integration component 212 may enable dynamic reaction to container lifecycle events for agent injection and removal within the pods 124. It may interact with the container runtime interface (CRI) to manage agent deployment and lifecycle within containers.

The data store 208 is a persistent storage system that maintains critical records and protocols essential for the verification process. It could be implemented using high-performance solid-state drives (SSDs) or distributed storage systems for enhanced reliability and access speed.

The data store 208 may store an agent integrity registry 214 that is a secure database that maintains cryptographic hashes of approved versions of the agent 108. This agent integrity registry 214 serves as a trusted reference for the agent verification component 210 to verify the integrity of the agent 108 during the deployment process. It may use advanced data structures like Merkle trees for efficient storage and verification of large numbers of agent versions.

The data store 208 may store ZKP protocols 216 that may be used during the verification process. These could include various types of ZKP schemes such as zk-SNARKs (Zero-Knowledge Succinct Non-Interactive Argument of Knowledge) or zk-STARKs (Zero-Knowledge Scalable Transparent Argument of Knowledge), each offering different trade-offs in terms of proof size, verification time, and setup requirements.

In various embodiments, the agent verification system 116 may incorporate multiple processors 202 to enhance parallel processing capabilities. These could be high-performance CPUs or specialized cryptographic processors, allowing for simultaneous verification of multiple agents 108 across different nodes in the cluster 110. This multi-processor architecture enables the system to scale efficiently in large, containerized environments with numerous agents requiring verification.

The network interface 204 is a versatile communication component that may support various protocols such as TCP/IP, gRPC, or QUIC. This enables the agent verification system 116 to interact seamlessly with different types of containerized architectures 104 and adapt to diverse network environments. The network interface 204 may also implement advanced features like hardware offloading for improved performance in high-traffic scenarios.

In some implementations, the data store 208 may be realized as a distributed database system, enhancing scalability and resilience of the agent integrity registry 214 and ZKP protocols 216. This distributed approach allows for replication of critical data across multiple instances of the verification system in large-scale deployments, ensuring high availability and fault tolerance.

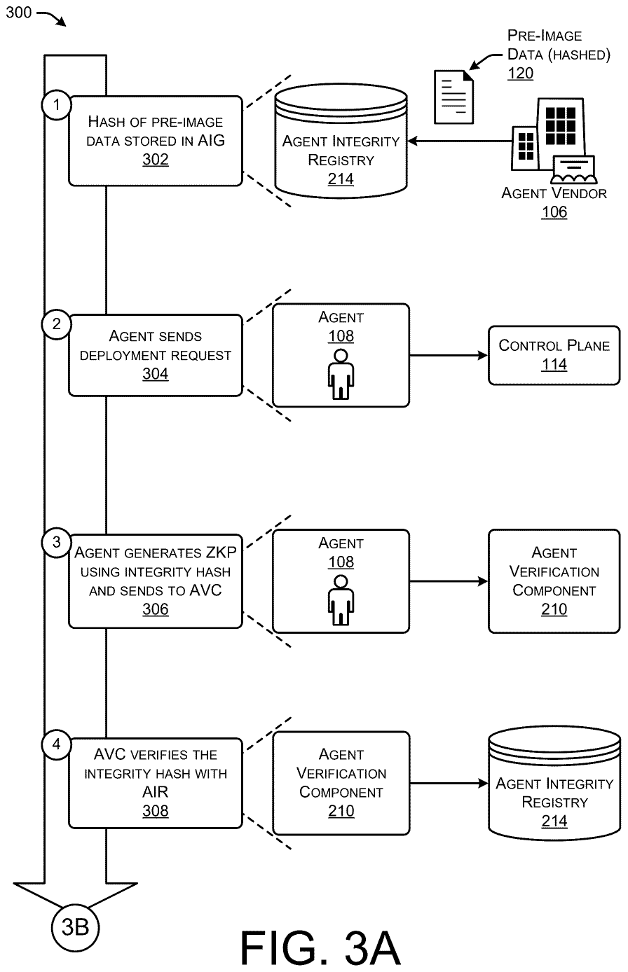

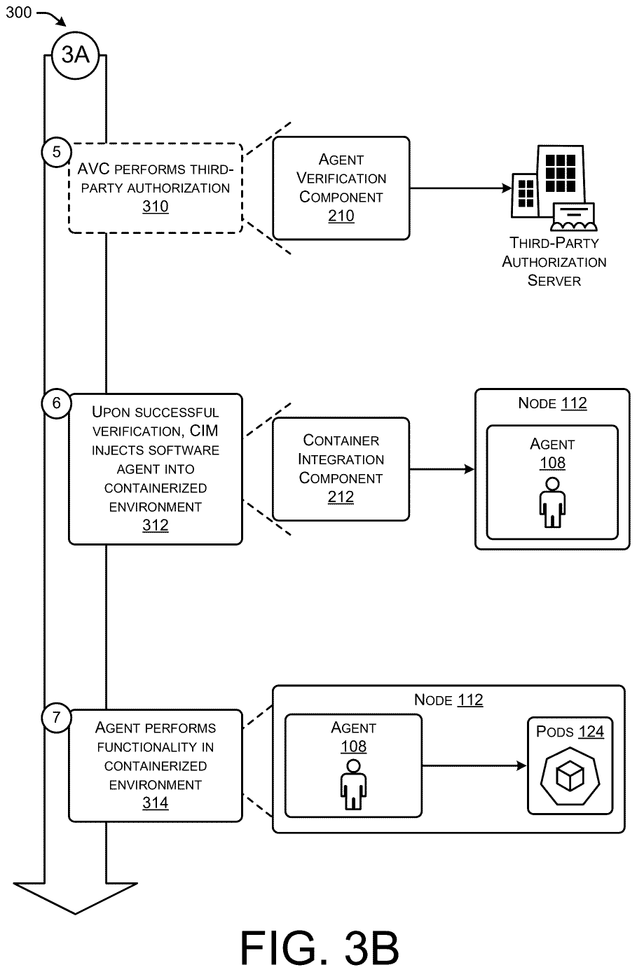

FIGS. 3A and 3B collectively illustrate a flow diagram of an example method 300 for an agent 108 to verify that it possesses pre-image data 120 that is approved for deployment into a computing system 102.

At 302, a hash of pre-image data 120 is stored in the agent integrity registry 214. This pre-image data 120, which represents the core code or configuration of the agent 108, is received from the agent vendor 106. The hashing process transforms the pre-image data 120 into a fixed-size string of characters, typically using a cryptographic hash function like SHA-256 or Blake2. This hash serves as a unique fingerprint of the agent's code, allowing for verification without exposing the actual code.

At step 304, the agent 108 initiates the deployment process by sending a deployment request to the control plane 114. This request signifies the agent's readiness to be integrated into the containerized environment. The control plane 114, acting as the central management entity, receives this request and prepares to orchestrate the verification and deployment process.

At 306, the agent 108 generates a zero-knowledge proof using its integrity hash. This proof is a cryptographic construct that allows the agent 108 to demonstrate knowledge of its pre-image data 120 without revealing the data itself. The agent 108 then sends this ZKP 118 to the agent verification component 210. This step leverages advanced cryptographic techniques such as zk-SNARKs or Bulletproofs to create a proof that is both convincing and privacy-preserving.

At 308, the agent verification component 210 verifies the integrity hash against the records in the agent integrity registry 214. This verification process involves complex cryptographic operations to validate the ZKP 118 without accessing the actual pre-image data 120. The component may use techniques like elliptic curve cryptography or pairing-based cryptography to efficiently verify the proof.

In some cases, the agent verification system 116 may perform additional verification steps to ensure the authenticity and integrity of the agent 108. These steps could include checking digital signatures, verifying certificate chains, or conducting behavioral analysis. For example, the agent verification system 116 may request third-party authorization as an optional step in the verification process. This could involve reaching out to a trusted certificate authority or a separate verification service to further validate the agent's credentials.

FIG. 3B illustrates a continuation of the flowchart depicting the method 300 for agent verification and deployment in a containerized environment, in accordance with one embodiment. This continuation builds upon the initial verification steps to ensure a comprehensive and secure deployment process.

At 310, the agent verification component 210 optionally performs a third-party authorization. This step involves communication with a third-party authorization server to further validate the agent 108. The authorization process may include checks against revocation lists, verification of digital signatures, or assessment of the agent's reputation score. This additional layer of verification enhances the overall security posture of the containerized architecture 104.

At 312, upon successful verification, the container integration component 212 injects the agent 108 into the containerized architecture 104. This injection process involves carefully orchestrating the deployment of the agent 108 into a node 112 within the cluster 110. The integration component may use container runtime interfaces or Kubernetes admission controllers to seamlessly introduce the agent 108 into the target environment.

At 314, the agent 108 begins performing its designated functionality within the containerized environment. This step demonstrates the agent 108 operating within the node 112 and interacting with the pods 124. The agent 108 may start monitoring system metrics, enforcing security policies, or performing other specialized tasks as per its design and configuration.

In various embodiments, the method 300 may incorporate additional verification steps between steps 308 and 310. For example, the agent verification system 116 may perform a series of integrity checks on the agent 108 before proceeding with third-party authorization. These checks could include static code analysis, dynamic behavior analysis, or compatibility testing with the target environment.

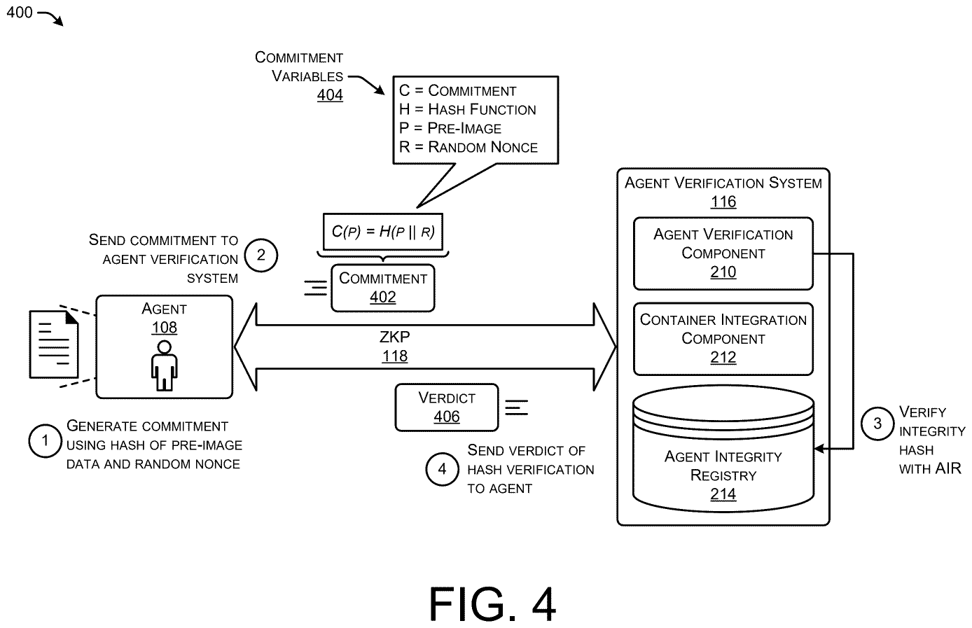

FIG. 4 illustrates an example diagram 400 in which an agent generates a commitment that proves to an agent verification system that the agent possesses approved pre-image data and is allowed to be deployed into a computing environment.

At “1,” the agent 108 may generate a commitment 402 (C) using commitment variables 404, such as a hash (H) of the pre-image data 120 (P) and random nonce (R). The agent 108 may generate a commitment 402 using the commitment variables 404, where the commitment 402 may be expressed as C(P)=H(P∥R). The agent 108 may, at “2,” send the commitment 402 to the agent verification system 116 via a ZKP 118.

The agent verification system 116 may include the agent verification component 210, the container integration component 212, and the agent integrity registry 214. The agent verification component 210 may receive and process the commitment 402 through the ZKP 118. The container integration component 212 may interface with the agent verification component 210 to manage container-related operations within the containerized architecture 104.

The agent integrity registry 214 may store integrity verification information. The agent verification component 210 may verify the integrity hash with the agent integrity registry 214. After verification, the agent verification component 210 may generate a verdict 406 which may be sent back to the agent 108 to indicate the result of the hash verification process.

The commitment scheme used in the commitment system may involve the use of a random nonce value as part of the commitment variables 404. This random nonce may enhance the security of the ZKP 118 by introducing an additional layer of unpredictability in the commitment generation process.

In various embodiments, the verdict 406 may include additional metadata beyond a simple binary result. This metadata may provide insights into the verification process, which may be used by the container integration component 212 to make more informed decisions about the deployment of the agent 108 within the pods 124.

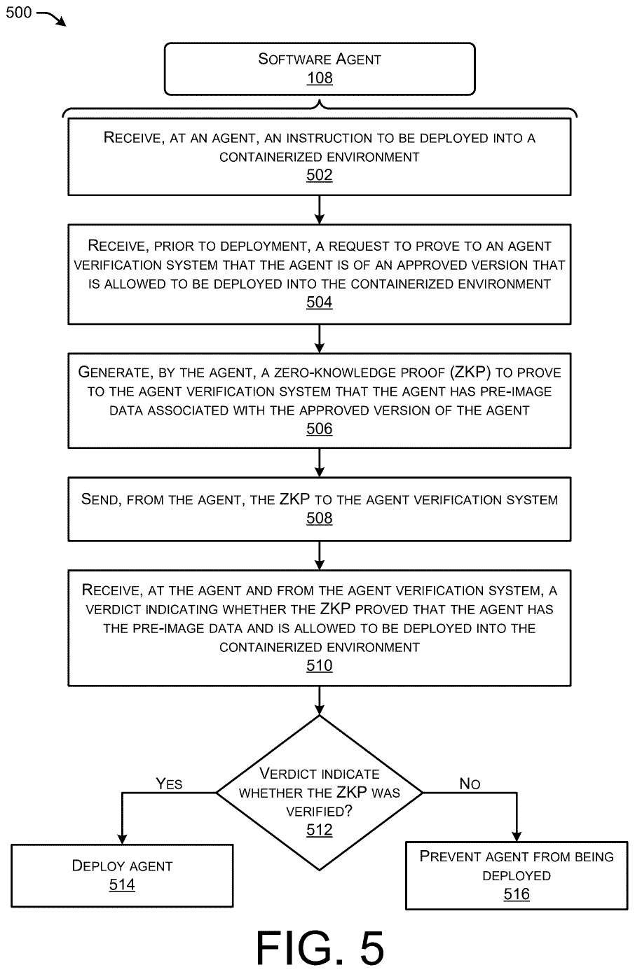

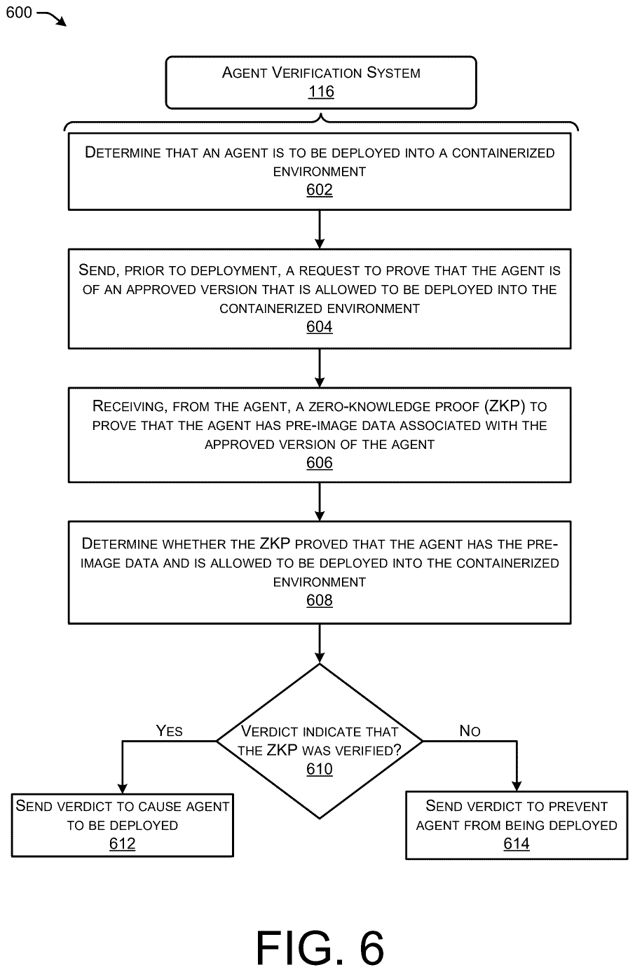

FIGS. 5 and 6 illustrate flow diagrams of an example methods 500 and 600 that illustrate aspect of the functions performed at least partly by the devices described in FIGS. 1-4, such as the agent 108, the agent verification system 116, and/or other devices or components. The logical operations described herein with respect to FIGS. 5 and 6 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 5 and 6 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 500 and 600 may be performed by a device and/or a system of devices that includes one or more processors and one or more non-transitory computer-readable media storing computer-executable instructions that, when executed by the one or more processors, cause the one or more processors to perform operations of methods 500 and 600.

FIG. 5 illustrates a flow diagram of an example method for an agent to utilize a ZKP to verify that it possesses pre-image data 120 that is approved for deployment into a computing environment.

At 502, an instruction may be received at the agent 108 to be deployed into a containerized environment. At 504, prior to deployment, a request may be received to prove to an agent verification system 116 that the agent 108 may be of an approved version allowed to be deployed into the containerized environment.

At 506, the agent 108 may generate a zero-knowledge proof to prove to the agent verification system 116 that the agent 108 has pre-image data associated with the approved version. At 508, the agent 108 may send the zero-knowledge proof to the agent verification system 116. At step 510, the agent 108 may receive a verdict from the agent verification system 116 indicating whether the zero-knowledge proof proved that the agent 108 has the pre-image data and may be allowed to be deployed into the containerized environment.

In some instances, the method 500 may further include, prior to generating the commitment, generating an integrity hash of the pre-image data. In such examples, calculating the hash may include applying a cryptographic hash function across at least the integrity hash and the random nonce.

At 512, the agent verification system 116 may determine whether the verdict indicates the zero-knowledge proof was verified. If the verdict indicates the zero-knowledge proof was verified, the method 500 may proceed to a step 514, where the agent 108 may be deployed. If the verdict indicates the zero-knowledge proof was not verified, the method 500 may proceed to a step 516, where the agent 108 may be prevented from being deployed.

In some cases, the agent 108 may be an observability agent designed to collect metrics, logs, and traces within the containerized environment. The agent 108 may monitor system performance, resource utilization, and application behavior within the containerized architecture 104.

In some cases, the pre-image data associated with the approved version of the agent 108 may include configuration files, binary code, or other identifying information that uniquely represents the approved state of the agent 108. This pre-image data may be used to generate the integrity hash that forms the basis of the zero-knowledge proof.

In some cases, the containerized environment may be a Kubernetes cluster 110, where the agent 108 may be deployed as a pod 124 within a node 112. The agent verification system 116 may work in conjunction with the control plane 114 to manage the deployment and verification process of the agent 108.

In various embodiments, the method 500 may be adapted to verify and deploy artificial intelligence (AI) agents in addition to observability agents. The zero-knowledge proof generation and verification process may be customized to accommodate the specific characteristics and security requirements of AI agents operating within the containerized architecture 104.

In various embodiments, the method 500 may incorporate multiple rounds of zero-knowledge proof generation and verification. For example, after the initial verification at step 510, the agent verification system 116 may request additional proofs or challenge responses from the agent 108 to further ensure its authenticity and integrity before making a final deployment decision.

In various embodiments, the method 500 may include a step for dynamically updating the agent integrity registry 214 with new approved versions of software agents. This may allow the system to adapt to frequent updates and changes in agent configurations while maintaining a secure verification process.

FIG. 6 illustrates a flow diagram of an example method 600 for an agent verification system 116 to utilize a ZKP 118 to verify that an agent 108 it possesses pre-image data 120 that is approved for deployment into a computing environment.

At step 602, the agent verification system 116 may determine that an agent 108 is to be deployed into a containerized architecture 104. This determination may be triggered by a deployment request received from the control plane 114 or directly from the agent 108.

At 604, prior to deployment, the agent verification system 116 may send a request to the agent 108 to prove that the agent 108 is of an approved version that is allowed to be deployed into the containerized architecture 104. This request may initiate the verification process to ensure the integrity and authenticity of the agent 108.

At 606, the agent verification system 116 may receive a zero-knowledge proof from the agent 108. The zero-knowledge proof may be designed to demonstrate that the agent 108 has pre-image data associated with the approved version of the agent 108, without revealing the actual pre-image data.

At 608, the agent verification system 116 may determine whether the zero-knowledge proof proved that the agent 108 has the pre-image data and is allowed to be deployed into the containerized architecture 104. This determination may involve verifying the zero-knowledge proof against information stored in the agent integrity registry 214.

In some instances, the agent verification system 116 may receive a random none, and the random nonce is usable by the agent verification system 116 to verify whether the commitment was generated using the pre-image data such that the agent has the pre-image data that is associated with the approved version of the agent.

At 610, the agent verification system 116 may make a decision based on whether the verdict indicates that the zero-knowledge proof was verified. This step may involve evaluating the results of the verification process performed in step 608.

If the verdict indicates the zero-knowledge proof was verified, the method 600 proceeds to a step 612, where the agent verification system 116 may send a verdict to cause the agent 108 to be deployed. This may involve instructing the container integration component 212 to inject the agent 108 into the node 112 that is appropriate within the cluster 110.

If the verdict indicates the zero-knowledge proof was not verified, the method 600 proceeds to a step 614, where the agent verification system 116 may send a verdict to prevent the agent 108 from being deployed. This may involve notifying the control plane 114 or other relevant components of the containerized architecture 104 that the deployment request for the agent 108 has been denied.

In some cases, the agent verification system 116 may utilize multiple verification techniques in addition to the zero-knowledge proof to enhance the security of the deployment process. For example, the agent verification system 116 may cross-reference the results of the zero-knowledge proof verification with historical deployment data or additional integrity checks.

In some cases, the pre-image data associated with the approved version of the agent 108 may include cryptographic hashes of the software agent's binary code, configuration files, or other identifying information. The agent verification system 116 may use these hashes as part of the verification process without directly accessing or exposing the sensitive information contained in the pre-image data.

In some cases, the containerized architecture 104 may be a Kubernetes cluster, and the agent verification system 116 may integrate with Kubernetes admission controllers to enforce the verification process as part of the pod 124 creation workflow. This integration may ensure that only verified agents 108 are allowed to be scheduled and run within the cluster 110.

In various embodiments, the method 600 may incorporate adaptive verification thresholds based on the current security posture of the containerized architecture 104. For example, during periods of heightened security concerns, the agent verification system 116 may require additional rounds of zero-knowledge proofs or implement stricter verification criteria before allowing deployment.

In various embodiments, the method 600 may include steps for continuous verification of deployed software agents. The agent verification system 116 may periodically challenge deployed agents to provide updated zero-knowledge proofs, ensuring ongoing compliance with approved versions and detecting any potential tampering or unauthorized modifications post-deployment.

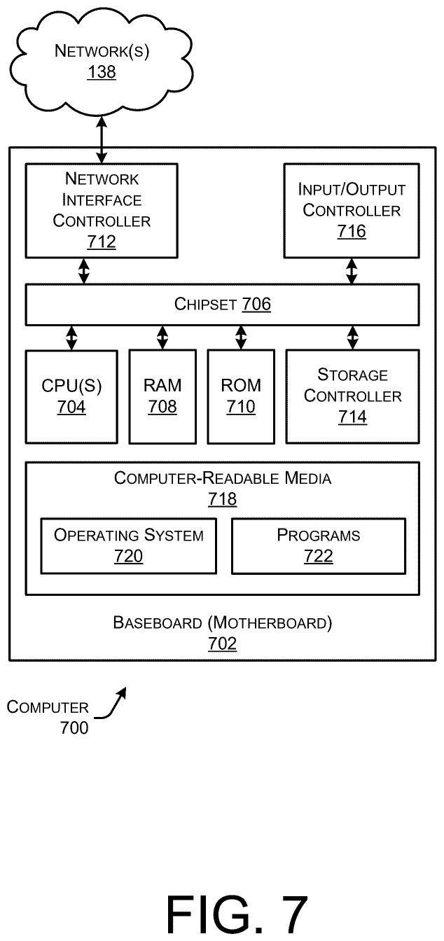

FIG. 7 shows an example computer architecture for a device capable of executing program components for implementing the functionality described above. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein.

As described herein, the agent 108 may run on the computer 700, or computers. Similarly, the computer 700 may be any type of device, such as network device or server. Thus, the computer 700 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (CPUs) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 138. The chipset 706 can include functionality for providing network connectivity through a NIC 712, such as a gigabit Ethernet adapter. The NIC 712 is capable of connecting the computer 700 to other computing devices over the network 138. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the agent 108, the agent verification system 116, and or any components included therein, may be supported by one or more devices similar to computer 700. Stated otherwise, some or all of the operations performed by agent 108 and/or the agent verification system 116, and or any components included therein, may be performed by one or more computer computers 700.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in the Figures, can include other components that are not explicitly shown in FIG. 7, or might utilize an architecture completely different than that shown in FIG. 7.

As described herein, the computer 700 may comprise one or more of a network any device in the computing system 102. The computer 700 may include one or more hardware processors (e.g., CPUs 704) configured to execute one or more stored instructions. The processor(s) may comprise one or more cores. Further, the computer 700 may include one or more network interfaces configured to provide communications between the computer 700 and other devices, such as the communications described herein as being performed by the agent 108 and/or the agent verification system 116. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A computer-implemented method for verifying an agent prior to deployment of the agent into a containerized environment, the computer-implemented method comprising:
sending, from the agent and to an agent verification system, a request to deploy the agent into the containerized environment;
prior to deployment of the agent, receiving a request to prove that the agent is of an approved version that is allowed to be deployed into the containerized environment;
generating a zero-knowledge proof (ZKP) to prove to the agent verification system that the agent has pre-image data associated with the approved version of the agent;
sending the ZKP to the agent verification system; and
receiving, from the agent verification system, a verdict indicating whether the ZKP proved that the agent has the pre-image data and is allowed to be deployed into the containerized environment.

2. The computer-implemented method of claim 1, wherein the generating the ZKP includes cryptographically obfuscating the pre-image data such that the ZKP represents an obfuscated version of the pre-image data that is verifiable by the agent verification system.

3. The computer-implemented method of claim 1, further comprising, in response to the verdict indicating that ZKP proved that the agent has the pre-image data, allowing the agent to be deployed in the containerized environment.

4. The computer-implemented method of claim 1, further comprising, in response to the verdict indicating that ZKP failed to prove that the agent has the pre-image data, preventing the agent from being deployed in the containerized environment.

5. The computer-implemented method of claim 1, wherein generating the ZKP comprises:
selecting a random nonce; and
generating a commitment by calculating a hash using at least the pre-image data and the random nonce such that the pre-image data is obfuscated using the random nonce prior to being sent to the agent verification system.

6. The computer-implemented method of claim 5, further comprising, prior to generating the commitment:
generating an integrity hash of the pre-image data,
wherein calculating the hash includes applying a cryptographic hash function across at least the integrity hash and the random nonce.

7. The computer-implemented method of claim 5, wherein sending the ZKP to the agent verification system comprises:
sending the commitment to the agent verification system; and
sending the random nonce to the agent verification system, wherein the random nonce is usable by the agent verification system to verify whether the commitment was generated using the pre-image data such that the agent has the pre-image data that is associated with the approved version of the agent.

8. A system comprising:
one or more processors; and
one or more non-transitory computer-readable media storing computer-executable instructions that, when executed by the one or more processors, cause the one or more processors to perform operations comprising:
sending, to an agent verification system, a request to deploy an agent into a containerized environment;
prior to deployment of the agent, receiving a request to prove that the agent is of an approved version that is allowed to be deployed into the containerized environment;
generating a zero-knowledge proof (ZKP) to prove to the agent verification system that the agent has pre-image data associated with the approved version of the agent;
sending the ZKP to the agent verification system; and
receiving, from the agent verification system, a verdict indicating whether the ZKP proved that the agent has the pre-image data and is allowed to be deployed into the containerized environment.

9. The system of claim 8, wherein the generating the ZKP includes cryptographically obfuscating the pre-image data such that the ZKP represents an obfuscated version of the pre-image data that is verifiable by the agent verification system.

10. The system of claim 8, the operations further comprising, in response to the verdict indicating that ZKP proved that the agent has the pre-image data, allowing the agent to be deployed in the containerized environment.

11. The system of claim 8, the operations further comprising, in response to the verdict indicating that ZKP failed to prove that the agent has the pre-image data, preventing the agent from being deployed in the containerized environment.

12. The system of claim 8, wherein generating the ZKP comprises:
selecting a random nonce; and
generating a commitment by calculating a hash using at least the pre-image data and the random nonce such that the pre-image data is obfuscated using the random nonce prior to being sent to the agent verification system.

13. The system of claim 12, the operations further comprising, prior to generating the commitment:
generating an integrity hash of the pre-image data,
wherein calculating the hash includes applying a cryptographic hash function across at least the integrity hash and the random nonce.

14. The system of claim 12, wherein sending the ZKP to the agent verification system comprises:
sending the commitment to the agent verification system; and
sending the random nonce to the agent verification system, wherein the random nonce is usable by the agent verification system to verify whether the commitment was generated using the pre-image data such that the agent has the pre-image data that is associated with the approved version of the agent.

15. A computer-implemented method comprising:
receiving, at an agent, an instruction to be deployed into a containerized environment;
prior to deployment of the agent, receiving, at the agent, a request to prove to an agent verification system that the agent is of an approved version that is allowed to be deployed into the containerized environment;
generating, by the agent, a zero-knowledge proof (ZKP) to prove to the agent verification system that the agent has pre-image data associated with the approved version of the agent;
sending, from the agent, the ZKP to the agent verification system; and
receiving, at the agent and from the agent verification system, a verdict indicating whether the ZKP proved that the agent has the pre-image data and is allowed to be deployed into the containerized environment.

16. The computer-implemented method of claim 15, wherein the generating the ZKP includes cryptographically obfuscating the pre-image data such that the ZKP represents an obfuscated version of the pre-image data that is verifiable by the agent verification system.

17. The computer-implemented method of claim 15, further comprising, in response to the verdict indicating that ZKP proved that the agent has the pre-image data, allowing the agent to be deployed in the containerized environment.

18. The computer-implemented method of claim 15, further comprising, in response to the verdict indicating that ZKP failed to prove that the agent has the pre-image data, preventing the agent from being deployed in the containerized environment.

19. The computer-implemented method of claim 15, wherein generating the ZKP comprises:
selecting a random nonce; and
generating a commitment by calculating a hash using at least the pre-image data and the random nonce such that the pre-image data is obfuscated using the random nonce prior to being sent to the agent verification system.

20. The computer-implemented method of claim 19, further comprising, prior to generating the commitment:
generating an integrity hash of the pre-image data,
wherein calculating the hash includes applying a cryptographic hash function across at least the integrity hash and the random nonce.
